(19) United States
(12) Patent Application Publication
(10) Pub. No.: US 2024/0300193 A1
(43) Pub. Date: Sep. 12, 2024

(54) METHOD FOR MANUFACTURING A PREFORM FOR A TURBOMACHINE COMPONENT AND INSTALLATION FOR WEAVING SUCH A PREFORM

(71) Applicant: SAFRAN AIRCRAFT ENGINES, Paris (FR)

(72) Inventors: Hubert Jean Marie FABRE, Moissy-Cramayel (FR); Raoul JAUSSAUD, Moissy-Cramayel (FR)

(21) Appl. No.: 18/272,767

(22) PCT Filed: Jan. 14, 2022
(86) PCT No.: PCT/FR2022/050082

§ 371 Date: Jul. 17, 2023

(30) Foreign Application Priority Data
Jan. 19, 2021 (FR) 2100489

(51) Int. Cl. B29C 70/48; B29B 11/16; B29L 31/00; D03D 49/20

(52) U.S. Cl. CPC B29C 70/48; B29B 11/16; D03D 49/20; B29L 2031/7504; D10B 2505/02

(57) ABSTRACT

A method for manufacturing a preform for a turbomachine component with a weaving installation including at least a first delivery roll and a storage roll. The method includes the following steps: —feeding the weaving installation with weft and warp filaments, —weaving the weft and warp filaments together to form the preform, —driving the preform in a direction of travel towards the storage roll, applying a predetermined tension on the preform, —winding the preform onto and storing it on the storage roll. The method also includes a step of immobilizing the preform on the first delivery roll positioned upstream of the storage roll in the direction of travel of the preform.

### FIELD OF THE INVENTION

This invention relates to the manufacture of a composite material component of turbomachine from a preform. It also aims to a weaving installation for the manufacturing of such a preform.

### TECHNICAL BACKGROUND

It is known that various turbomachine components, in particular for an aircraft turbomachine, can be made of a composite material in order to improve their thermomechanical resistance capabilities and reduce their weight. The composite material is made from a preform or fabric intended to form a fibrous reinforcement and which is embedded in a matrix. The preform is obtained by a three-dimensional weaving (or 3D weaving) or two-dimensional weaving (or 2D weaving).

Generally speaking, the weaving of the preform is carried out using a weaving installation with a Jacquard-type loom. The weaving installation is fed with a number of weft and warp filaments which are caused to interweave or interlace in a predetermined weave to form the preform. The nature of the weft and warp filaments and the selected armature will define the mechanical properties of the preform and also of the component of the turbomachine. For this purpose, the installation comprises a weaving reed located in a weaving area where the preform (where the filaments are woven) is obtained at the exit. The preform (thus woven) is wound and stored on a take-up roll referred to as “take-up”, which is arranged downstream of the weaving reed. The take-up roll is driven in rotation about an axis of rotation by means of a motor so as to pull the preform while applying a tension to it according to the installation. In order to facilitate the pulling and the routing of the preform to the take-up roll, a first delivery roll is mounted just at the exit of the weaving area and upstream of the take-up roll. Examples of a weaving installation are described in the documents FR-A13066429 and WO-A1-2017/149252.

When weaving the preform, the preform may slide on the first delivery roll, causing the meshes, particularly the weft meshes, to be spaced (or loosened) or tightened (or contracted) (referred to as “pick spacing”). This anomaly also occurs almost exclusively during stopping the weaving installation, which may occur for the maintenance of the installation, during an incident during the operation of the installation, or for a replenishment of filaments, etc. The preforms made with a non-woven textile such as in the document FR-A1-3085126 do not encounter pick spacing problems. At standstill, a drop in tension was observed at the level of the take-up roll, which had repercussions on the first delivery roll, causing the loosening or tightening of the meshes.

### SUMMARY OF THE INVENTION

The aim of the present invention is to provide a solution allowing to ensure the reliable tension throughout the weaving process, while at the same time being economical and simple.

This objective is achieved in accordance with the invention by means of a method for manufacturing a preform for a turbomachine component using a weaving installation comprising at least a first delivery roll and a take-up roll, the method comprising the following steps:
feeding the weaving installation with weft and warp filaments,
weaving the weft and warp filaments so as to form a preform,
driving the preform in a direction of travel towards the take-up roll which applies a predetermined tension to the preform, and
winding and storing the preform around the take-up roll, the method comprising a step of immobilising the preform on the first delivery roll arranged upstream of the take-up roll in the direction of travel of the preform.

Thus, this solution allows to achieve the above-mentioned objective. In particular, immobilising the preform, coming off the loom, on the first delivery roll prevents the preform from sliding towards the reed (located upstream of the first delivery roll) or towards the take-up roll which applies a tension to the preform. The meshes of the preform (between the weft and warp filaments), in particular the weft meshes (“spick spacing”), are controlled and uniform; they are no longer too tight or too spaced (especially in case of a loosening of the tension on one of the two sides of the preform) and any mechanical weaknesses once the composite material component made from this preform has been obtained are avoided.

The method also comprises one or more of the following steps and/or characteristics, taken alone or in combination:
the immobilisation step is carried out by means of a flange arranged close to the first delivery roll.
the flange is removable.
the flange moves towards the first delivery roll so that the preform is compressed between the first delivery roll and the flange.
the flange moves substantially in a direction orthogonal to the direction of movement of the preform.
the movement of at least the movable portion of the flange is manual.
the movement of at least the movable portion of the flange is motorised.
the installation is connected to an electronic control system configured to control the stopping and the starting of the installation, the electronic control system being connected to a moving member for setting in motion the flange so that when it receives an information about stopping the installation, a control command is sent to the moving member.
the flange applies a pressure of between 0.1 and 2 MPa to the first delivery roll.
the preform is made using a three-dimensional interlock weaving, a three-dimensional weaving or a two-dimensional weaving.

The invention also relates to a weaving installation for the manufacturing of a preform for a turbomachine component, the installation comprising:
a stationary structure,
at least one take-up roll for the preform, mounted so as to rotate about a first axis of rotation relative to the structure, the take-up roll being intended to apply a tension to the preform, which is intended to be driven in a direction of movement towards the take-up roll and to wind around the latter,
at least one first delivery roll mounted upstream of the take-up roll and movable in rotation about a second axis of rotation relative to the structure, and
a flange configured so as to immobilise the preform on the first delivery roll when the installation stops.

The installation also comprises one or more of the following characteristics, taken alone or in combination:
the flange is removably attached to the stationary structure.
at least a portion of the flange is movable relative to the first delivery roll via at least one moving member which is attached to the structure and connected to the flange.
the flange comprises a bearing surface oriented towards the first roll and having a shape complementary to a peripheral surface of the first roll or of the preform.
the flange comprises a support member and a member which is movable or flexible relative to the support member, the flexible or movable member carrying the bearing surface.
the bearing surface comprises a coating made of a polymeric material.
the first delivery roll is intended to drive the preform at a predetermined speed.

The invention also relates to a method for manufacturing a turbomachine component made of composite material comprising a fibrous reinforcement densified by a matrix, the method comprising the following steps:
manufacturing a preform as described above,
placing the preform around a mandrel forming a mould,
installing a counter-mould around the preform placed on the mandrel so as to form an injection chamber,
injecting a matrix into the injection chamber,
polymerising the matrix,
demoulding the composite material component.

The invention also relates to a turbomachine casing made of composite material comprising a fibrous reinforcement densified by a matrix, the casing being produced by the method having any one of the above steps and/or characteristics.

The invention also relates to a turbomachine comprising at least one casing made of composite material as described above.

The invention also relates to an aircraft comprising at least one turbomachine as mentioned above.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is a partial axial sectional view of an example of a turbomachine to which the invention applies;

FIG. 2 is a very schematic view of a weaving installation for manufacturing a preform according to the invention;

FIG. 3 is a schematic view in axial cross-section of another portion of the weaving installation which comprises at least a take-up roll for storing the preform obtained at the exit of a loom according to the invention;

FIG. 4 is a schematic and detail view of a first delivery roll of the weaving installation cooperating with a flange which is intended to immobilise the preform in the event of stopping the weaving installation according to the invention; and

FIG. 5 is a schematic and detailed view of another embodiment of a first delivery roll of the weaving installation equipped with a flange intended to immobilise the preform if the weaving installation according to the invention is stopped.

### DETAILED DESCRIPTION OF THE INVENTION

FIG. 1 shows a partial and axial cross-section of a turbomachine 1 of longitudinal axis X, which comprises various members that can be made of composite materials. The invention is of particular interest to the turbomachine members or components which have an axis of revolution, such as fan casings, compressor casings, turbine casings etc.

The turbomachine shown in FIG. 1 is a double-flow, two-spool turbomachine intended to be mounted on an aircraft. The turbomachine 1 comprises a fan 2 which is mounted upstream of a gas generator 3 or engine along the flowing of the gases in the turbomachine and here along the longitudinal axis X (and even from left to right in FIG. 1). The gas generator comprises, from upstream to downstream, a low-pressure compressor 4a, a high-pressure compressor 4b, a combustion chamber 5, a high-pressure turbine 6a and a low-pressure turbine 6b.

The fan 2 is surrounded by a fan casing 7, which is extended downstream by an intermediate casing shell (referred by its acronym “ICS”) 8. This intermediate casing shell is attached to the fan casing 7. This shell 8 can also be made of a composite material and thus fall within the scope of the invention. The intermediate casing shell 8 is connected to an inter-duct casing 12 of the turbomachine via several structural arms 14 arranged regularly around the longitudinal axis. The intermediate casing shell 8 supports the fan casing 7 and also an external nacelle 13. The nacelle 13 and the fan casing 7 are centred on the longitudinal axis. The fan 2 divides the air entering the turbomachine into a primary air flow that passes through the gas generator 3, in particular in a primary duct 9, and a secondary air flow that circulates around the gas generator in a secondary duct 10. The gas generator is housed inside an internal casing 11. The inter-duct casing 12 surrounds the internal casing 11. The inter-duct casing 12 delimits the radially internal wall of the secondary duct 10. The primary and secondary ducts 9, 10 are concentric. This inter-duct casing 12 and the internal casing 11 comprise various structural casings surrounding the compressors and the turbines.

At least one of the turbomachine casings or shells is produced by a method for manufacturing a composite material component with a fibrous reinforcement embedded in a matrix. The fibrous reinforcement is obtained by a method for manufacturing a preform 15 (or fibrous texture or fabric) made in a three-dimensional weaving (or 3D weaving) of filaments. In the present invention, the term “three-dimensional weaving” or “3D weaving” is understood to mean a weaving mode in which warp filaments are connected to weft filaments in several layers. The preform could also be produced using a three-dimensional interlock weaving or “3D interlock weaving”. The term “3D interlock weaving” refers to a weaving method in which several layers (made up of warp and weft filaments) are bonded together. The preform 15 can also be obtained with a two-dimensional weaving (or 2D weaving).

The preform 15 is woven using a weaving installation 16 comprising a loom 17 configured for three-dimensional and/or two-dimensional weaving. The fibre reinforcement comprises a plurality of warp filaments and a plurality of weft filaments which are respectively oriented in directions which are perpendicular. Advantageously, the weaving is carried out flat so that when it leaves the loom 17, the preform 15 obtained is also in the general form of a flat strip with varying thicknesses.

In the present example, the filaments or strands for making the weaving comprise fibres made of carbon, glass, ceramic, silica, silicon carbide, Kevlar, polyamide, alumina or a mixture of these fibres. Preferably, but not exclusively, the filaments are made of carbon.

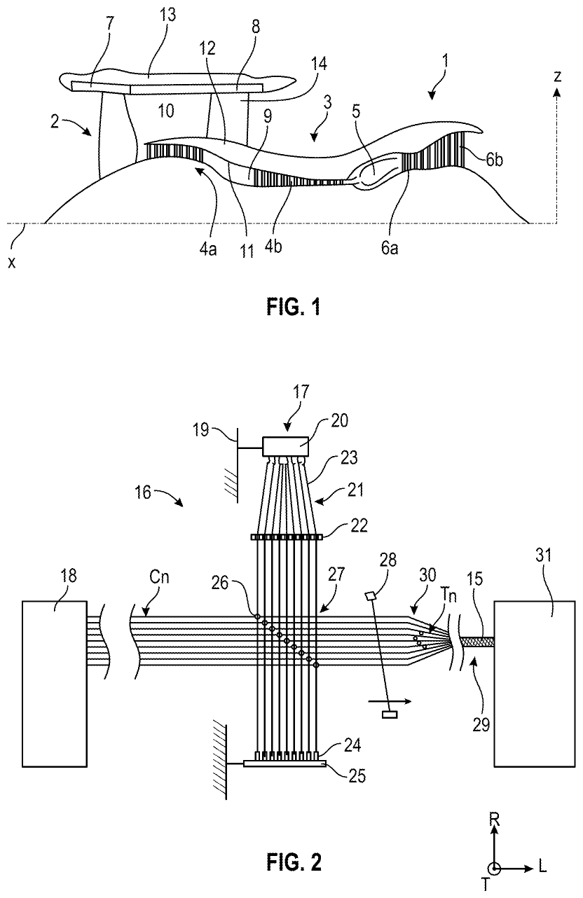

FIG. 2 shows an example of a weaving installation 16 which extends in a longitudinal direction L, has a height in a radial direction R and a width in a transverse direction T. The directions are perpendicular to each other. The weaving installation 16 comprises a system 18 for feeding filaments intended for use as warp filament Cn and which are stored on several coil. The feeding system allows a better distribution of the warp filaments, which are arranged in several layers and superimposed in the radial direction R (so as to give a thickness to the fabric). The warp filaments are also arranged in the transverse direction (to give a width to the fabric). The loom 17 shown is of the Jacquard type and is arranged on a first structure 19 which extends in the radial direction. In particular, the loom 17 comprises a loom head 20 which radially surmounts a harness 21 consisting of a perforated comber board 22 and several heddles 23 which pass through the comber board. The comber board is arranged above the connection/weaving areas in the vertical direction. Each heddle 23 is connected at a first end to the loom head 20 and at a second opposite end to return springs 24 which are secured to a frame 25 of the first structure 19 of the loom. Each heddle 23 is in the form of a metallic rod and comprises at least one eyelet 26 through which a warp filament from the feeding system 18 passes. Alternatively, each heddle consists of a flexible filament which is hooked to a metallic rod comprising the eyelet. This configuration allows the heddles 23 to support the warp filaments Cn.

During the weaving, the harness 21 is set in motion in the vertical direction and in a connection area 27 of the warp filaments and the heddles (with the eyelets) so as to allow the introduction of the weft filaments later after the shed has been opened. The vertical amplitude of the movement of the heddles 23 determines the different layers and thicknesses of the preform. When the harness 21 is set in motion, some of the heddles rise vertically while the others fall, and vice versa.

The installation 16 also comprises a weaving reed 28 which is arranged along the direction of advance of the warp filaments between the connection area 12 and a weaving area 29 where the preform 15 is obtained (the weft and warp filaments are interlaced). At the level of the reed 28 is located an insertion area 30 for weft filaments Tn (the shed), which are routed by a shuttle (not shown). The weft filaments Tn extend into this insertion area 30 in the transverse direction. The weaving reed 28 comprises a plurality of teeth through each of which the warp filaments Cn pass. Typically, the weaving reed 28 is driven in a back and forth movement relative to the longitudinal direction, allowing the weft filaments Tn, which interlace the warp filaments Cn, to be packed onto the preform 15 already woven in the weaving area 29.

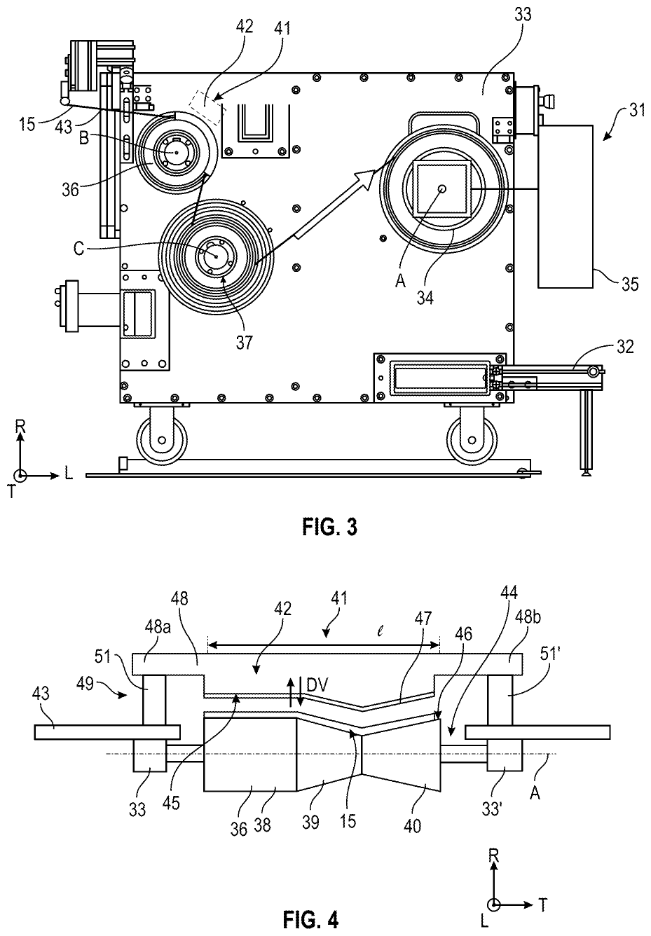

FIG. 3 shows an axial cross-section of another portion of the weaving installation 16, where the preform 15, which has previously been woven in the form of a strip of fabric, is wound onto a take-up roll 34. This other portion is a storage unit 31 located downstream of the weaving area. The storage unit 31 comprises a second structure 32 with a first partition 33 and a second partition 33′ (see FIG. 4) which are opposite each other in the transverse direction. The take-up roll 34 is mounted on the second structure 32 and extends transversely between the first and second partitions 33, 33′. The take-up roll 34 is also movable in rotation about a first axis of rotation A and in a first direction of rotation. This first axis of rotation A is perpendicular to the longitudinal direction L (according to the reference frame shown in FIG. 3). During the weaving, the preform 15 is wound onto this take-up roll 34, which applies a tension to it. To achieve this, the take-up roll is connected to a motor (not shown) which is controlled by an electronic control system 35. The take-up roll applies a tension of between 1500 and 4500 Newton. The motor delivers a torque that drives the take-up roll 34 in rotation and allows the tension to be applied to the preform that is coupled to the take-up roll 34. The angular speed of the take-up roll 34 is discontinuous (the roll 34 advances in jerks). In particular, for a 2D weaving, the roll 34 advances incrementally with each insertion of a weft filament and potentially constantly. For a multi-layer weaving, the roll 34 stops until all the weft filaments of the column have been inserted (so that they are well above each other) and then advances by one increment for the insertion of n weft filaments of the next column.

The installation 16 is also connected to the electronic control system, which controls its start-up and shut-down.

At least a first delivery roll 36 referred to as “puller” is located upstream of the take-up roll 34 so as, on the one hand, to drive the preform (make it advance) and, on the other hand, to guide the preform towards the take-up roll and to distribute the tension of the take-up roll 34 more evenly. The first delivery roll 36 is arranged downstream of the loom. In the present example, the first delivery roll 36 is carried by the second structure 32 as can be seen in FIG. 3 and extends transversely between the first and the second partitions 33, 33′. Alternatively (not shown), the first delivery roll 36 is mounted on the first structure 19.

The first delivery roll 36 is also driven in rotation by a motor about a second axis of rotation B. The second axis of rotation B is parallel to the first axis of rotation A. In particular, the roll 36 is driven at a specific speed (the speed determines the weft meshes). Next, the take-up roll 34 is controlled in terms of tension (direct application or servo-control with a feedback loop using a tension measurement on intermediate rolls described below). The tension applied by the take-up roll 34 allows to press the preform against the first delivery roll 36. The first delivery roll 36 still has a sufficient coefficient of friction to allow an adequate adhesion with the preform. Advantageously, the delivery roll 36 is equipped with a coating with a high coefficient of friction to help pull the fabric. Its direction of movement is advantageously identical to that of the take-up roll 34. In another example of embodiment, the delivery roll 36 can rotate in the opposite direction to the take-up roll 34. In this case, for example, the preform can pass under the take-up roll to be wound.

At least one second delivery roll 37 referred to as “reverser” is also mounted in rotation on the second structure 32 along a third axis of rotation C, which is parallel to the axis B. Several second delivery rolls 37 (referred to as intermediate rolls) can be installed between the delivery roll 36 and the take-up roll 34. Each second roll 37 allows a homogeneous application of the tension. In fact, the preform may have a different length between each second roll (preform woven “in shape” using the “contour weaving” method—i.e. the preform is non-developable), which implies adjusting the length covered by the preform between the first delivery roll 36 and the take-up roll 34. In this way, thanks to the second (intermediate) delivery roll or rolls, the length of the preform is different at each axial position of a second roll. In the absence of this second roll or these second rolls 37, the tension applied by the take-up roll 34 may be concentrated in an area where the preform is shortest and generate sliding.

With reference to FIG. 3, the second roll 37 is mounted to rotate freely (unlike the delivery roll 36 and the take-up roll 34). In particular, the second roll 37 is located along the longitudinal direction L between the first roll 36 and the take-up roll 34. This second roll is also located at a different radial height to the first roll 36 and to the take-up roll 34. It can be lower or higher depending on requirements.

FIG. 4 shows the first delivery roll 36 in more detail. The latter has a generally hourglass-shaped axial cross-section. The first roll 36 can be of any shape, with different curvilinear, conical or frustoconical segments of varying degrees of prominence. In other words, the shape of the first roll 36 is said to be evolving. Typically, the shape of the axial cross-section of the roll corresponds to the profile of the casing or of the shell to be manufactured. In the example shown very schematically in FIG. 4, the first delivery roll has a cylindrical first portion 38 centred on the axis A and a conical or frustoconical second portion 39 which extends the first portion, the base of the second portion being connected to the first portion. The first roll also comprises a conical or frustoconical third portion 40, the summit of which is connected to that of the second portion. Alternatively, the second portion is cylindrical and the first and third portions, which extend transversely on either side of the second roll, are frustoconical in shape. The first delivery roll 36 is made from a single piece of material (came with matter or monobloc). Alternatively, the first delivery roll 36 is made from several portions which are assembled using suitable attachment means (welding, screws, bolts, studs, etc.).

The installation 16 comprises an element 41 for immobilising the preform on the first delivery roll 36 when the installation is at a standstill (in particular during prolonged stoppages). This immobilisation element 41 prevents the preform from sliding upstream (towards the weaving area 29) or downstream of the first roll 36 (towards the take-up roll 34) as a result of a drop in tension on one of the two sides of the first roll 36 (either on the side of the take-up roll 34, or on the side of the weights which are on the coils mounted in the feeding system 18). The tension on the side of the take-up roll is due to the fact that it pulls the preform downstream. Upstream there is also a resistive tension due to the weight of the coils and of the weights, and the friction of the filaments on the various portions of the installation (eyelet, comb, etc.).

In the present example, the immobilising element 41 comprises a wedge or a flange 42 which is mounted close to the first delivery roll 36. Advantageously, the flange 42 is arranged at the level of a support table 43 for the preform 15 leaving the loom. In particular, as can be seen in FIG. 4, a space 44 is provided in the support table 43 to receive at least partly the first roll 36. The preform is supported by the first delivery roll 36 at the level of this space 44. Alternatively, the flange can be positioned elsewhere on the second structure. The flange must not prevent the first roll from rotating during operation of the installation.

The flange 42 has a bearing surface 45 which has a complementary shape to a peripheral surface 46 of the first roll 36. In this example, the support surface 45 is intended to adapt to the shape of the first roll and/or to the preform. In other words, the bearing surface 46 faces the roll 36 (with the preform). In this example, the flange 42 also comprises a support member 48 which supports the bearing surface 45. Advantageously, the flange 42 is made of a metallic material. One example of a metallic material under consideration is aluminium, which is light and economical. This is around 5 cm thick to ensure a sufficient rigidity. The flange also has a width I in the transverse direction (relative to the reference frame in FIG. 4) of between 70 cm and 190 cm. In particular, the flange has a width substantially identical to that of the first roll 36.

According to the example shown in FIG. 4, the bearing surface 45 comprises a coating 47 which allows to respect the physical integrity of the preform and to better distribute the pressure of the flange 42 applied to the preform 15 or the first roll 36. The coating 47 is made from a polymer material such as an elastomer (neoprene, silicone). This coating 47 can allow the bearing surface 45 to adapt to the shape and/or to the thickness of the preform running on the first delivery roll 36.

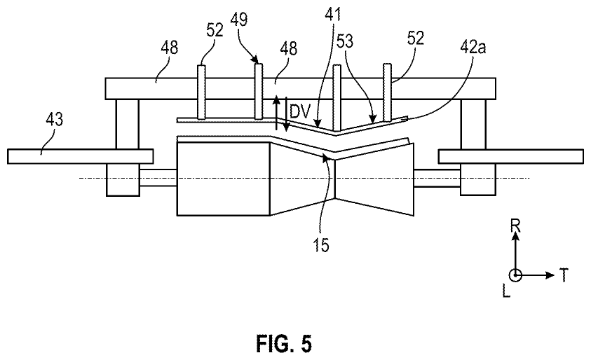

Alternatively, as shown in FIG. 5, the flange 42 comprises a movable member 42a which supports the bearing surface 45. In particular, the movable member is in the form of a flexible metallic sheet-metal 42a (very thin) so as to adapt to the shape of the roll 36 and/or of the preform 15. The metallic material is, for example, aluminium or steel. The sheet 42a is held by the support member 48, which is in the form of a rigid transverse bar (along the transverse direction T). The support member 48 is made of a metallic material. The sheet 42a extends mainly in the transverse direction T.

In another variant, not shown, so that the bearing surface adapts to the shape of the first roll and/or to the preform, the flange comprises a flexible member. The flexible member is formed by a flexible bladder which is mounted on the support member. The bladder is arranged radially between the rigid support member 48 and the preform. The bladder forms a closed chamber that is designed to be inflated (to fill its volume) by a fluid. The bladder is kept under pressure by the fluid inside it or by an external pressurisation system connected to the bladder. The bladder is also made from a polymer material such as silicone.

When the loom or even the installation is stopped, the operator places the flange on the first roll so that a segment of the preform is compressed or squeezed between the first delivery roll 36 and the flange 42. To this end, attachment members 50 such as screws, studs and nuts are used to attach the flange in position on the second structure and/or in particular here on the support table 43.

In another embodiment, the flange 42 comprises at least one portion which is mounted so as to be movable relative to the first roll 36. Advantageously, but without limitation, at least one portion of the flange moves substantially in a direction orthogonal to the direction of movement of the preform. To this end, as can be seen in FIG. 4, the flange is equipped with a moving member 49 which is attached to the second structure. This moving member comprises a first actuator 51 which is connected to a first end 48a of the support member 48 of the flange and a second actuator 51′ which is connected to a second end 48a of the flange. The first and second actuators 51, 51′ move vertically in the radial direction. The actuators are controlled by the electronic control system 35. In this way, when information about stopping the installation is received by the electronic control system, the latter sends a control command to the moving member 49 for setting in motion the flange to move the flange towards the first delivery roll 36. In this way, the preform 15 is compressed between the first delivery roll 36 and the flange 42.

In the example of embodiment shown in FIG. 5, a moving member for setting in motion at least one portion of the flange 42 is also provided. In this case, the movement is manual following a vertical translation (in the radial direction) as represented by the arrows DV. The flexible metallic sheet-metal 42a is removable and movable relative to the support member 48 and also relative to the roll 36. To achieve this, the moving member 49 comprises adjusting screws 52 which are each received in a bore in the support member 48. Here, the bores comprise an internal thread. When each adjusting screw 52 is screwed into its bore, its free end comes into abutment against an external surface 53 of the sheet-metal 42a (radially opposite the bearing surface 45 carried here by the sheet-metal). According to an alternative of this example of embodiment, the moving member comprises adjustment rods which are secured to the external surface of the sheet and which are each intended to pass through a bore in the support member. A nut is mounted on the side of the free ends of the rods to attach the position of the sheet on the preform 15.

In the case of FIG. 5, at least the sheet-metal 42a is fitted and removable. This is best done manually. The leg 54 then presses the flange against the preform.

In yet another embodiment, at least one portion of the flange moves in rotation, the axis of rotation of which is orthogonal to the direction of movement of the preform. To this end, each first and second end of the flange or of the movable member (or flexible member (metallic sheet-metal)) is connected to an arm which is mounted so as to rotate about an axis parallel to the axis of the first roll. The arms are pivotally mounted on the second structure (or the support table). The arms are controlled by the electronic control system to move them towards the first roll when the latter receives information that the installation has stopped. The rotational movement of the arm would allow a greater amplitude of movement and a better clearance of the area comprising the space 44 when the flange 42 is not in use.

In a variant of this embodiment, the operator lowers the flange manually towards the first roll when the installation is at a standstill.

The flange can apply a compression or compaction pressure to the first delivery roll of between 0.1 Mpa and 2 Mpa.

Once the preform has been obtained, it is cut (end of weaving scrap) and then unwound from the take-up roll 34.

The method for manufacturing the turbomachine component also comprises a step of placing the preform around a mandrel that has the shape of the turbomachine casing. This mandrel has an axis of revolution and forms the injection mould into which the resin will be injected to densify the preform and obtain the desired component. The injection mould has a geometry identical to that of the final component. After winding around the injection mould, the preform is cut to the right length to fill a portion of the injection chamber. A counter-mould is applied around the preform to form the injection chamber.

The method comprises a step of injecting a matrix using RTM technology, which stands for Resin Transfer Moulding. In this description, the terms “resin” and “matrix” are equivalent. The matrix allowing a densification of the fibrous reinforcement may be a polymeric matrix such as an epoxy-based thermosetting resin. The polymeric matrix may also be a thermoplastic resin. The impregnation of the preform with the resin is optimised by applying pressure in the injection chamber. Other methods such as infusion, resin transfer moulding (RTM light) or injection moulding of a resin between the preform and a flexible membrane (referred to as Polyflex) are of course also possible.

We obtain a rigid component after a curing or polymerisation of the matrix and without excessive tightening or loosening of the meshes in the fibrous reinforcement. The final composite material component is then de-moulded. Machining and piercing operations may be carried out on the resulting casing at the end of the method.

1. A method for manufacturing a preform for a turbomachine component using a weaving installation comprising at least a first delivery roll and a take-up roll, the method comprising the following steps:
feeding the weaving installation with weft (Tn) and warp (Cn) filaments,
weaving the weft and warp filaments together to form the preform,
driving the preform in a direction of travel towards the take-up roll which applies a predetermined tension on the preform, and
winding and storing the preform around the take-up roll, wherein it comprises a step of immobilising the preform on the first delivery roll arranged upstream of the take-up roll in the direction of travel of the preform when the installation is stopped.

2. The manufacturing method according to claim 1, wherein the immobilisation step is carried out by means of a flange arranged close to the first delivery roll.

3. The manufacturing method according to claim 2, wherein at least one portion of the flange moves towards the first delivery roll so that the preform is compressed between the first roll and the flange.

4. The manufacturing method according to claim 3, wherein the movement of at least the movable portion of the flange is manual or motorised.

5. The manufacturing method according to claim 3, wherein the installation is connected to an electronic control system configured to control the stopping and the starting of the installation, the electronic control system being connected to a moving member for setting in motion the flange so that when it receives an information about stopping the installation, a control command is sent to the moving member.

6. The manufacturing method according to claim 1, wherein the flange applies a pressure to the first delivery roll of between 0.1 Mpa and 2 Mpa.

7. A weaving installation for manufacturing a preform for a turbomachine component, the weaving installation comprising:
a stationary structure,
at least one take-up roll for the preform mounted so as to rotate about a first axis of rotation (A) with respect to the structure, the take-up roll being intended to apply a tension to the preform which is intended to be driven in a direction of movement towards the take-up roll and to be wound around the latter,
at least one first delivery roll mounted upstream of the take-up roll and movable in rotation about a second axis of rotation (B) relative to the structure, and,
a flange configured so as to immobilise the preform on the first delivery roll when the installation stops.

8. The weaving installation according to claim 7, wherein at least a portion of the flange is movable relative to the first delivery roll via at least one moving member which is attached to the structure and which is connected to the flange.

9. The weaving installation according to claim 7, wherein the flange comprises a bearing surface oriented towards the first delivery roll and which has a complementary shape with a peripheral surface of the first delivery roll or of the preform.

10. The weaving installation according to claim 9, wherein the flange comprises a support member and a member which is movable or flexible relative to the support member, the movable or flexible member carrying the bearing surface.

11. The weaving installation according to claim 10, wherein the bearing surface comprises a coating made of a polymeric material.

12. A method for manufacturing a turbomachine component of composite material comprising a fibrous reinforcement densified by a matrix, the method comprising the following steps:
manufacturing a preform according to claim 1,
placing the preform around a mandrel forming a mould,
installing a counter-mould around the preform placed on the mandrel so as to form an injection chamber,
injecting a matrix into the injection chamber,
polymerising the matrix,
demoulding the composite material component.
